(19) United States
(12) Patent Application Publication
(10) Pub. No.: US 2003/0219192 A1
(43) Pub. Date: Nov. 27, 2003

(54) Localized hermetic seal for planar lightwave circuits

(75) Inventors: Douglas E. Crafts, San Jose, CA (US); James F. Farrell, San Jose, CA (US); Mark B. Farrelly, San Jose, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS UNIPHASE CORPORATION, San Jose, CA

(21) Appl. No.: 10/429,189

(22) Filed: May 7, 2003

Related U.S. Application Data
(60) Provisional application No. 60/380,009, filed on May 7, 2002.

(51) Int. Cl. G02B 6/12

(52) U.S. Cl. 385/14

(57) ABSTRACT

Planar lightwave circuits (PLCs) are typically provided with a passivation coating layer to prevent damaging effects of environmental factors. In certain cases, deep trenching or a similar procedure after passivation removes the protective passivation coating, exposing the underlying layers. Without the passivation coating, the exposed core and cladding layers may absorb moisture resulting in an unacceptable shift in their refractive index. A supplemental hermetic sealing technique suitable for use in localized areas of a PLC, e.g., in areas where passivation may have been removed, consists of providing a sealing lid having a sealing surface, and diffusion-bonding the sealing surface of the sealing lid to the bonding surface about the PLC area. Preferably, prior to said diffusion bonding, the upper bonding surface about the PLC area and the sealing surface of the sealing lid are smoothed to facilitate the bonding.

### RELATED APPLICATIONS

This Application is related to the following commonly assigned, co-pending U.S. Patent Applications, each of which is incorporated by reference herein in its entirety. In addition, in accordance with this invention, the principles set forth herein can be used in combination with any of the techniques disclosed in any of the following Applications:

Ser. No. 09/901,474 entitled “Redundant Package for Optical Components” filed Jul. 9, 2001;

Ser. No. 09/977,065 entitled “Waveguide Stress Engineering and Compatible Passivation in Planar Lightwave Circuits” filed Oct. 12, 2001;

Ser. No. 10/010,931 entitled “High Thermal Efficiency, Small Form-Factor Packages Including Thermally Insulative Cavities, and Transfer Molded Variants” filed Nov. 20, 2001;

Ser. No. 10/001,266 entitled “Precision Fiber Optic Alignment and Attachment Apparatus” filed Nov. 30, 2001;

Ser. No. 10/077,581 entitled “Compact, Low Insertion Loss, High Yield Arrayed Waveguide Grating” filed Feb. 15, 2002;

Ser. No. 10/099,565 entitled “Multi-Band Arrayed Waveguide Grating With Improved Insertion Loss and Wavelength Accuracy” filed Mar. 15, 2002; and

Ser. No. 10/100,277 entitled “Transfer Molded Packages With Embedded Thermal Insulation ” filed Mar. 18, 2002.

This application claims priority from U.S. Provisional Application No. 60/380,009 filed May 7, 2003.

### BACKGROUND OF THE INVENTION

Planar Lightwave Circuits (PLCs) form a class of optical components known for their similarity to wafer-based, electrical integrated circuits. In PLCs, wafer-based deposition and etching techniques are used to form the core and cladding layers of optical waveguides. These waveguides can be arranged in the form of, for example, an arrayed waveguide grating (“AWG”) providing multiplexing and demultiplexing of individual wavelengths in a dense wavelength division multiplexing (“DWDM”) system. Waveguides are also run from the functional AWG to/from the edges of the resultant PLC die, where they are interfaced to fiber optic arrays.

Higher levels of die-level integration are now being considered. For example, optical components providing additional optical functionality can be designed into the waveguide paths on the die (e.g., optical switches and attenuators).

As discussed in the above-incorporated U.S. Patent Application entitled “Waveguide Stress Engineering and Compatible Passivation in Planar Lightwave Circuits,” a final step in PLC formation may involve the deposition of a passivation layer designed to seal the underlying waveguides from adverse environmental conditions (e.g., humidity).

In certain PLC components, however, deep trenching (after passivation) may be needed to provide certain optical functionality, improve optical performance, and/or relieve stresses. Deep trenching removes the protective passivation, exposing the underlying layers to moisture. Device reliability depends on a stable refractive index in the waveguide core and cladding layers. Without the passivation coating, the exposed core and cladding layers may absorb moisture resulting in an unacceptable shift in their refractive index.

What is required, therefore, are supplemental, hermetic sealing techniques suitable for use in a localized area or areas of a PLC requiring additional sealing, e.g., in areas where passivation may have been removed.

### SUMMARY OF THE INVENTION

In accordance with one aspect of the invention, there is provided a method for sealing an area of a planar lightwave circuit (PLC), the method comprising the steps of:

providing the PLC having a bonding surface about the area;

providing a sealing lid having a sealing surface; and

diffusion-bonding the sealing surface of the sealing lid to the bonding surface about the PLC area.

Preferably, prior to said diffusion bonding, the upper bonding surface about the PLC area, and the sealing surface of the sealing lid are smoothed to facilitate the diffusion bonding.

In accordance with another aspect of the invention, there is provided an optical component, including a planar lightwave circuit (PLC) having an area requiring a seal, the component comprising:

a sealing lid having a sealing surface diffusion-bonded to a bonding surface about said area, thereby providing a seal over said PLC area.

### BRIEF DESCRIPTION OF THE DRAWINGS

The invention will be described in more detail by way of the following description showing exemplary, non-limiting embodiments of the invention, in conjunction with the drawings, in which

FIG. 1 is a partial cross-sectional view of a typical waveguide configuration of a PLC structure, and

FIG. 2 is a schematic representation of a sealing procedure according to the invention.

### DETAILED DESCRIPTION OF THE INVENTION

In accordance with one aspect of the present invention, a low temperature diffusion bonded (e.g., glass) seal is used for locally sealing an area of a PLC. A separate glass sealing lid is provided (or a lid to which a glass surface can be bonded), along with a glass layer as an upper bonding surface of the PLC.

The seal is achieved by planarizing a sealing surface, typically a perimeter surface of the sealing lid, and the upper bonding surface about the PLC area of interest, followed by placing the two together under elevated temperature and pressure. The two sealing surfaces, e.g. glass surfaces, diffuse together forming a hermetic seal with little or no additional stresses in the glass.

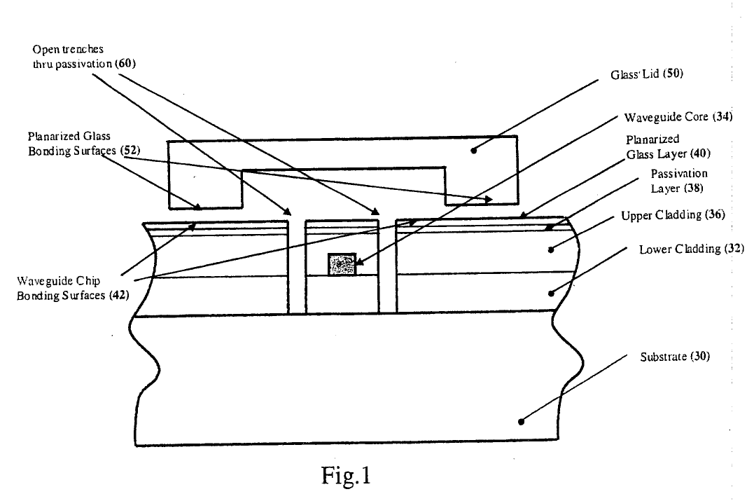

FIG. 1 depicts in partial cross-section a typical wafer-based “silica-on-silicon” waveguide configuration, used for waveguides of a PLC structure—e.g., an AWG or variable optical attenuator (“VOA”). A buffer layer 32 (e.g., a thermal oxide or SiO2) is formed (e.g., grown or deposited) over a silicon substrate 30. Though various deposition/formation techniques are disclosed herein, those skilled in the art will recognize that any number of known techniques can be used without departing from the principles of the present invention.

Buffer 32 serves as the “undercladding” for the waveguide core 34, which can be formed from a doped silica glass layer (e.g., doped with phosphorous, germanium, nitride, or any other dopant(s) which appropriately modify the refractive index upward—phosphate silicate glass (“PSG”) being one example). This layer is etched using, e.g., photolithographic mask and reactive ion etching (RIE) techniques. The term “core” is used broadly herein to connote any type of structure within which light is guided. An “overcladding” layer formed from a doped silicate glass layer 36 (e.g., doped with boron, fluorine, phosphorous, germanium, nitride, or any dopant(s) which appropriately modify the refractive index downward—boro-phosphate silicate glass (“BPSG”) being one example) is then deposited over the cores to complete their waveguide configuration, using, e.g., chemical vapor deposition (“CVD”) or other known processes.

As discussed above, a passivation layer 38 can optionally be employed to seal the entire waveguide structure using, e.g., a CVD process. In one embodiment, silicon nitride is used, but other materials are possible. This passivation layer can be used in combination with certain stress engineering techniques employed in the lower layers. The composition of this layer, and its deposition process, can be specially tailored to avoid interfering with the stress balancing in the lower layers. For example, a silicon nitride film can be used (e.g., Si₃N₄). Any other suitable passivation materials may be used for layer 108, including for example, hydrogenated silicon nitride of the form SiₓN_{y}H_{z}; or silicon-oxy-nitride of the form SiₓO_{y}N_{z} (with or without hydrogen).

In accordance with the present invention, another glass layer 40 (e.g., silica glass) can be deposited over passivation layer 38 using known techniques. This layer will form the contact surface 42 about this functional PLC area for sealing lid 50 at its perimeter bonding surface 52. Layer 40 is preferably deposited (using, e.g., CVD) and then planarized to an appropriate smoothness using, e.g., chemical mechanical polishing (“CMP”) or other suitable planarization technique. A flatness of 1 micrometer across a 1 centimeter distance is preferable, and scratches should be limited to 20 angstroms, and digs to 10 angstroms.

As discussed above, trenches 60 may be etched into this PLC area for reasons related to function, performance and/or stress release. The trenches, however, pierce the protective passivation layer 38 and therefore expose the underlying functional layers to moisture and other environmental conditions.

In accordance with the present invention, a sealing lid 50 is provided, having a perimeter surface 52 suitable for diffusion bonding onto corresponding surface 42 about the PLC area of interest. The entire lid 50 can be glass, or alternatively, smaller block(s) of glass can be affixed to the lower portion of the lid to provide perimeter bonding surface 52. The glass composition of this perimeter surface can also be silica, but need not necessarily be the same as layer 40. Perimeter surface 52 should also be planarized to the smoothness parameters of surfaces 42 discussed above. Only a cross-section of the lid is shown in FIG. 1, but those skilled in the art will recognize that this sealing surface runs along the entire perimeter of the three-dimensional lid to effectively seal a localized area of the PLC over which the lid is placed.

The cavity formed within the perimeter of lid 50 offers the opportunity to seal other devices requiring optical or physical engagement to the sealed area of the PLC. For example, an electro-optic sensing device (e.g., diode) can be pre-placed in the cavity, for functional engagement to an underlying PLC structure (e.g., tap) thereby providing an additional level of functionality in the hermetically sealed cavity.

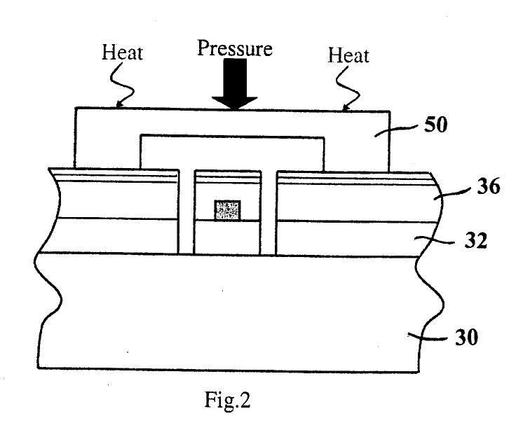

A diffusion bonding technique is employed to affix the lid to the PLC die. As shown in FIG. 2, this involves the application of pressure and heat to the mating surfaces 42 and 52 to induce diffusion bonding between the surfaces at the molecular level, thereby hermetically sealing the PLC area of interest (and any devices pre-placed in the cavity). Low temperature bonding can be used to decrease any resultant stress on the PLC area.

The typical conditions for glass to glass fusion bonding are as follows:

Temperature : 25 to 700 degrees C.

Pressure: 0.1 Mpa to 2.0 Mpa

Time: 1 to 100 hours

If the temperature is relatively high, the time and pressure can be relatively low.

The surfaces must be polished and particle-free.

Low temperature processes require plasma surface activation.

Size range used in PLC: 4 mm×4 mm up to 50 mm×50 mm would be a practical range. Above this size, there may no longer be much of an advantage over complete hermetic packaging. Typically, the PLC lids are between 3 mm to 6 mm tall with a 1.5 to 4 mm cavity.

The present invention offers hermetic sealing of a localized area of a PLC. This sealing can be used alone, or in combination with any other sealing techniques (passivation and packaging), examples of which are provided throughout the above-incorporated U.S. Patent Applications. The sealed areas can be trenched areas, and/or active component areas (e.g., taps, VOAs) separate from a central AWG, or any other areas requiring supplemental sealing.

1. An optical component, including a planar lightwave circuit (PLC) having an area requiring a seal and a bonding surface about the area, the component comprising:
a sealing lid having a sealing surface diffusion-bonded to the bonding surface about said PLC area, thereby providing a seal over said PLC area.

2. The optical component of claim 1, wherein the sealing surface of the sealing lid comprises a smoothed glass layer, and the bonding surface about the PLC area comprises a smoothed glass layer.

3. The optical component of claim 2, further comprising:
a protective passivation layer formed under the smoothed glass layer of the PLC area, the passivation layer at least partially interrupted in the PLC area.

4. The optical component of claim 1, further comprising:
an additional device pre-placed in a cavity within the perimeter surface of the sealing lid, for functional engagement with the PLC area.

5. A method for sealing an area of a planar lightwave circuit (“PLC”), the method comprising the steps of:
providing the PLC having an upper bonding surface about the PLC area;
providing a sealing lid having a sealing surface; and
diffusion-bonding the sealing surface of the sealing lid to the upper bonding surface about the PLC area.

6. The method of claim 5, further comprising:
prior to said diffusion bonding, smoothing the upper bonding surface about the PLC area, and the sealing surface of the sealing lid.

7. The method of claim 5, further comprising:
prior to said diffusion bonding, placing an additional device in a cavity within the sealing surface of the sealing lid, for functional engagement with the PLC area.
